(19) United States
(12) Patent Application Publication
(10) Pub. No.: US 2017/0026461 A1
(43) Pub. Date: Jan. 26, 2017

(54) INTELLIGENT LOAD BALANCER

(71) Applicant: Cisco Technology, Inc., San Jose, CA (US)

(72) Inventors: Sami Boutros, San Ramon, CA (US); Rex Fernando, San Jose, CA (US); Muthurajah Sivabalan, Kanata (CA); Bertrand Duvivier, Wepion (BE)

(21) Appl. No.: 14/809,095

(22) Filed: Jul. 24, 2015

(51) Int. Cl. H04L 29/08; H04L 12/755; H04L 12/723; H04L 12/803

(52) U.S. Cl. CPC H04L 67/101; H04L 47/125; H04L 45/021; H04L 45/50

(57) ABSTRACT

Systems, methods, and computer-readable media for an intelligent load balancer. In some embodiments, a system can analyze activity data for egress links associated with a network. The system can also receive a service request originating from a remote device. Next, the system can select a server in the network for receiving the service request. Based on the activity data, the system can also select an egress link from the egress links for communicating data associated with the service request from the network to a remote destination location, such as the remote device. The system can then send a signal to the selected server which can include the service request and an indication of the egress link to be used for the data associated with the service request. The system can also later change the selected egress link for the service request if the system subsequently identifies a better egress link.

### TECHNICAL FIELD

The present technology pertains to load balancing and more specifically to load balancing egress links in datacenters for servicing requests.

### BACKGROUND

The ubiquity of Internet-enabled devices has created an enormous demand for Internet services and content, such as over the top (OTT) services. In many ways, we have become a connected society where users are increasingly reliant on Internet services and content. This Internet-connected revolution has created significant challenges for service and content providers who often struggle to service a high volume of user requests without falling short of user performance expectations. For example, providers typically need extremely large and complex datacenters to keep up with user demands for Internet services and content. These datacenters are generally equipped with server farms configured to host specific services, and include vast numbers interconnected switches and routers configured to route traffic in and out of the datacenters. In many instances, a specific datacenter is expected to handle millions of traffic flows and service requests. Not surprisingly, such large volumes of data can be difficult to manage and create significant performance degradations and challenges. Current solutions typically address performance challenges by deploying additional hardware in the datacenter, thereby increasing the resources and performance capabilities of the datacenter. Unfortunately, adding more hardware can be very expensive and complicated.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a diagram of an example communication network;

FIG. 2 illustrates a diagram of a network architecture of a data center;

FIG. 3 illustrates a schematic diagram of an example system for intelligent load balancing;

FIG. 4 illustrates an example diagram of a forwarding table for intelligent load balancing;

FIG. 5 illustrates an example method embodiment;

FIG. 6 illustrates an example network device; and

FIG. 7A and FIG. 7B illustrate example system embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to perform intelligent load balancing of egress links for servicing requests received by a network, such as a datacenter, from remote devices and locations. The specific egress link for traffic egressing out of the network can be selected from multiple possible egress links intelligently to improve performance and efficiency, lower or minimize cost, and increase quality and reliability. The specific egress link can be selected based on a variety of factors, such as cost, bandwidth, latency, packet loss, resource consumption and/or availability, current or past load, service criteria or requirements, etc. The intelligent load balancer can monitor traffic and egress links and dynamically modify egress link use or assignments, in order to adapt to the current circumstances and conditions in the network. In some cases, an intelligent load balancer can select a server to handle or process a service request, and initiate a modification to the server's forwarding table to map the service request to a specific egress link intelligently selected for that service request from multiple egress links in the network. This way, the intelligent load balancer can ensure that the server will use the specific egress link when responding to the service request.

Disclosed are systems, methods, and computer-readable storage media for an intelligent load balancer. In some embodiments, a system can analyze activity data for egress links associated with a network. The system can also receive a service request originating from a remote device. Next, the system can select a server in the network for receiving the service request. Based on the activity data, the system can also select an egress link from the egress links for communicating data associated with the service request from the network to a remote destination location, such as the remote device. The system can then send a signal to the selected server which can include the service request and an indication of the egress link to be used for the data associated with the service request.

### DESCRIPTION

A computer network can include a system of hardware, software, protocols, and transmission components that collectively allow separate devices to communicate, share data, and access resources, such as software applications. More specifically, a computer network is a geographically distributed collection of nodes interconnected by communication links and segments for transporting data between endpoints, such as personal computers and workstations. Many types of networks are available, ranging from local area networks (LANs) and wide area networks (WANs) to overlay and software-defined networks, such as virtual extensible local area networks (VXLANs), and virtual networks such as virtual LANs (VLANs) and virtual private networks (VPNs).

LANs typically connect nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. LANs and WANs can include layer 2 (L2) and/or layer 3 (L3) networks and devices.

The Internet is an example of a public WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks may be further interconnected by intermediate network nodes, such as routers, switches, hubs, or access points (APs), which can effectively extend the size or footprint of the network.

Networks can be segmented into subnetworks to provide a hierarchical, multilevel routing structure. For example, a network can be segmented into subnetworks using subnet addressing to create network segments. This way, a network can allocate various groups of IP addresses to specific network segments and divide the network into multiple logical networks.

In addition, networks can be divided into logical segments called virtual networks, such as VLANs, which connect logical segments. For example, one or more LANs can be logically segmented to form a VLAN. A VLAN allows a group of machines to communicate as if they were in the same physical network, regardless of their actual physical location. Thus, machines located on different physical LANs can communicate as if they were located on the same physical LAN. Interconnections between networks and devices can also be created using routers and tunnels, such as VPN or secure shell (SSH) tunnels. Tunnels can encrypt point-to-point logical connections across an intermediate network, such as a public network like the Internet. This allows secure communications between the logical connections and across the intermediate network. By interconnecting networks, the number and geographic scope of machines interconnected, as well as the amount of data, resources, and services available to users can be increased.

Further, networks can be extended through network virtualization. Network virtualization allows hardware and software resources to be combined in a virtual network. For example, network virtualization can allow multiple numbers of VMs to be attached to the physical network via respective VLANs. The VMs can be grouped according to their respective VLAN, and can communicate with other VMs as well as other devices on the internal or external network.

To illustrate, overlay networks generally allow virtual networks to be created and layered over a physical network infrastructure. Overlay network protocols, such as Virtual Extensible LAN (VXLAN), Network Virtualization using Generic Routing Encapsulation (NVGRE), and Stateless Transport Tunneling (STT), provide a traffic encapsulation scheme which allows network traffic to be carried across L2 and L3 networks over a logical tunnel. Such logical tunnels can be originated and terminated through virtual tunnel end points (VTEPs). The VTEPs can tunnel the traffic between an underlay network and any overlay network, such as a VXLAN, an NVGRE, or a STT, for example.

Moreover, overlay networks can include virtual segments, such as VXLAN segments in a VXLAN overlay network, which can include virtual L2 and/or L3 overlay networks over which VMs communicate. The virtual segments can be identified through a virtual network identifier (VNI), such as a VXLAN network identifier, which can specifically identify an associated virtual segment or domain.

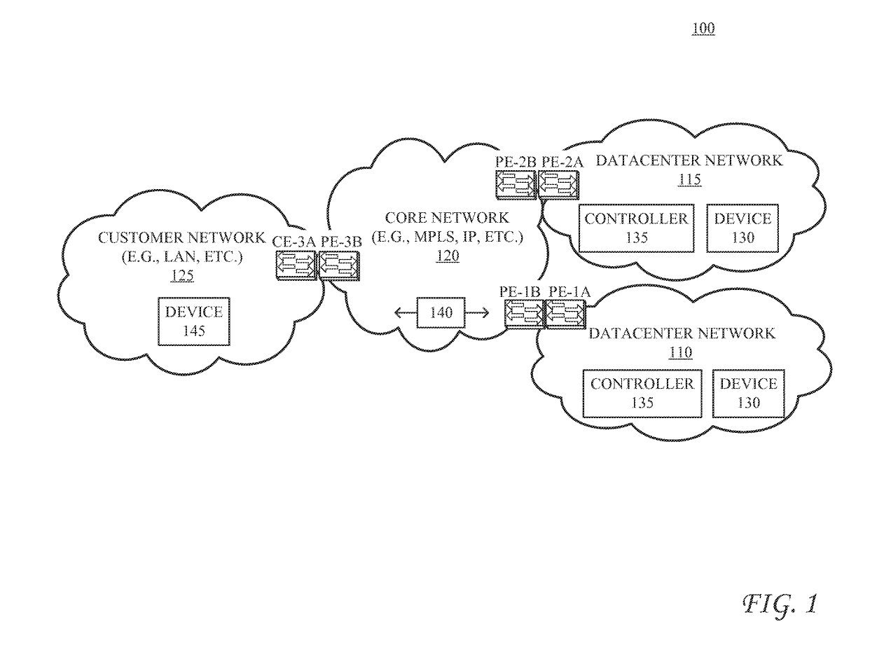

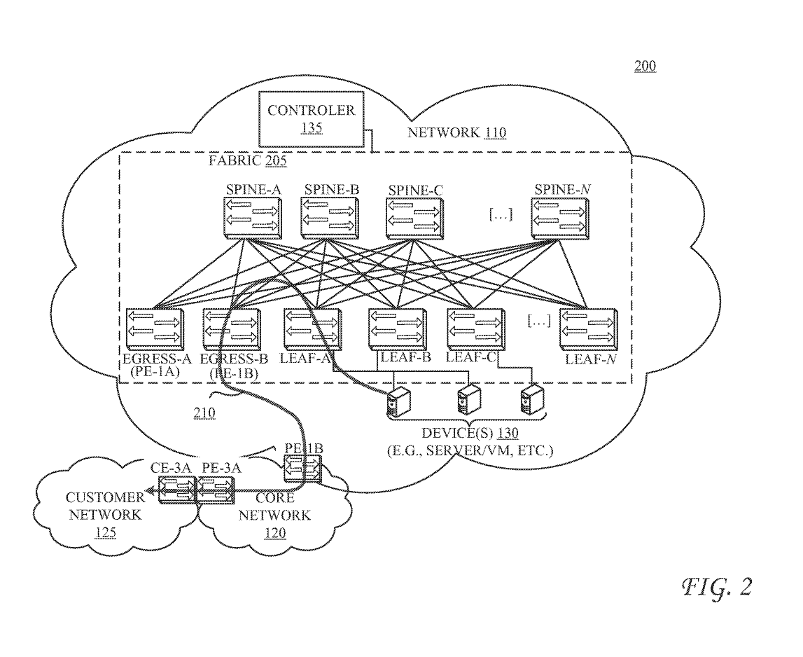

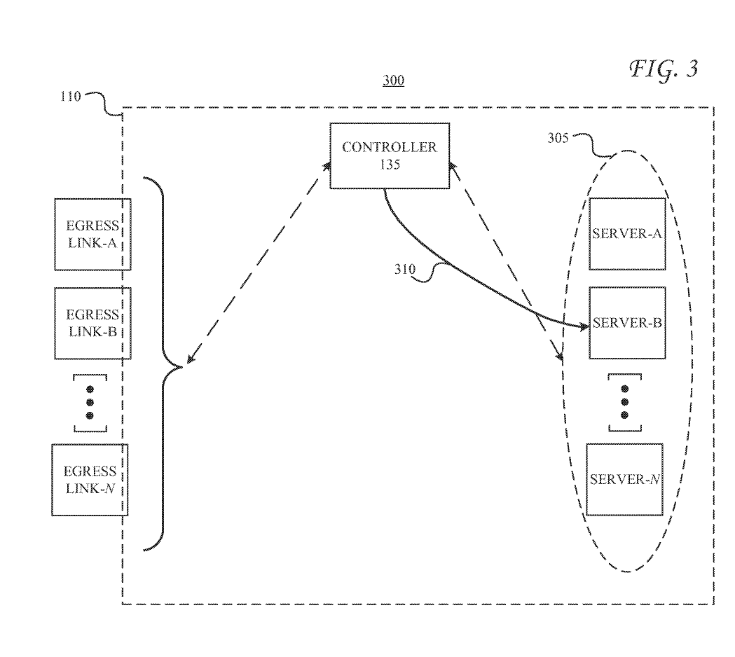

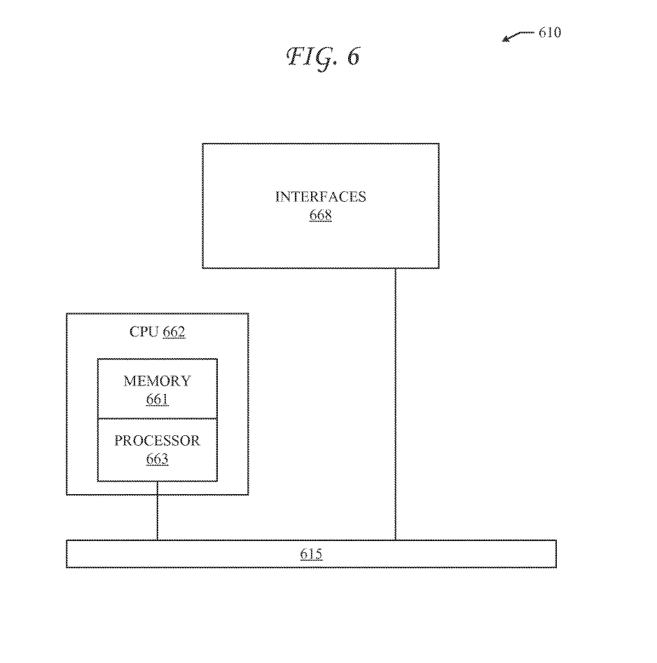

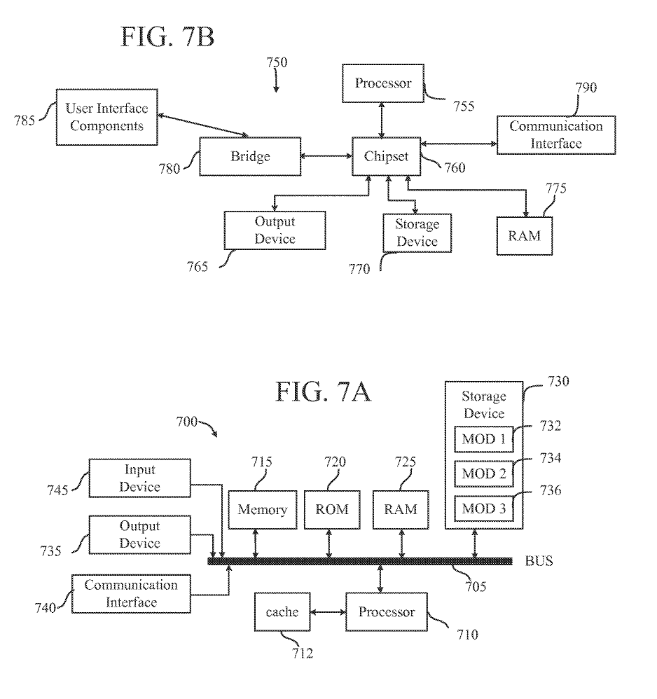

The disclosed technology addresses the need in the art for intelligent load balancing. Disclosed are systems, methods, and computer-readable storage media for an intelligent load balancer. A description of network computing environments and architectures, as illustrated in FIGS. 1-2, is first disclosed herein. A discussion of intelligent load balancing, as illustrated in FIGS. 3-5, will then follow. The discussion then concludes with a description of example devices, as illustrated in FIGS. 6 and 7A-B. These variations shall be described herein as the various embodiments are set forth. The disclosure now turns to FIG. 1.

FIG. 1 is a schematic block diagram of an example communication network 100 illustratively including networks 110, 115, 120, and 125. As shown, networks 110, 115 can include one or more virtual and/or physical networks, such as one or more datacenters, local area networks (LANs), virtual local access networks (VLANs), overlay networks, etc. Network 120 can include a core network, such as an IP network and/or a multiprotocol label switching (MPLS) network. In some embodiments, network 120 can be a services provider (SP) network. Customer network 125 can be a client or subscriber network. Moreover, customer network 125 can include one or more networks, such as one or more LANs, for example. Each of networks 110, 115, 120, and 125 can include nodes/devices (e.g., routers, switches, servers, firewalls, gateways, client devices, printers, etc.) interconnected by links, networks, and/or sub-networks. Certain nodes/devices, such as provider edge (PE) devices (e.g., PE-1A,B, PE-2A,B, and PE-3B) and a customer edge (CE) device (e.g., CE-3A), can communicate data such as data packets 140 between networks 110, 115, and 125 via core network 120 (e.g., between device 145, devices 130, and controllers 135 for respective networks).

Data packets 140 can include network flow(s), traffic, frames, and/or messages, for example. Moreover, the data packets 140 can be exchanged among the nodes/devices of communication network 100 over links and networks using network communication protocols, such as Transmission Control Protocol/Internet Protocol (TCP/IP), User Datagram Protocol (UDP), MPLS, VXLAN, etc.

The PE devices (e.g., PE-1A,B, PE-2A,B, and PE-3B) and CE device(s) (e.g., CE-3A) can serve as gateway for respective networks, and can represent an egress and/or ingress point for electronic traffic entering the respective networks. Further, the PE devices (e.g., PE-1A,B, PE-2A,B, and PE-3B) and CE device(s) (e.g., CE-3A) can process, route, treat, and/or manage individual packets. For example, the PE devices (e.g., PE-1A,B, PE-2A,B, and PE-3B) and CE device(s) (e.g., CE-3A) can designate and/or flag individual packets for particular treatment.

Those skilled in the art will understand that any number of nodes, devices, links, networks, topologies, protocols, etc. may be used in the communication network 100, and that the view shown herein is a non-limiting example for explanation purposes. Further, the embodiments described herein may apply to any other network configuration.

FIG. 2 illustrates an example network architecture 200 for a data center in accordance with some embodiments. The architecture 200 can include network 110, core network 120, and customer network 125. As discussed above, network 110 can represent a data center and may include physical and/or virtual systems and networks. For example, network 110 can include a network fabric (e.g., fabric 205) which can provide the underlay (i.e., physical network) for routing traffic in the network 110. In some cases, the fabric can route traffic to specific nodes (e.g., devices 130) for servicing service requests received by network 110, such as requests from clients or devices in the customer network 125.

Fabric 205 can be configured according to a specific topology, such as spine-leaf, CLOS or folded CLOS, fat tree, three layer architectures, top-of-rack (ToR), etc. In some embodiments, fabric 205 can include spine switches A-N (spine-A-spine N), and leaf switches A-N. Fabric 205 can also include one or more gateways (e.g., egress-A and egress-B) configured as egress and/or ingress links for the network 110. The gateways (egress-A-egress-B) can be leaf switches. For example, egress-A can be a leaf switch and can correspond to PE-1A. Spine switches A-N can include L2 and/or L3 switches. Spine switches A-N can be configured to lookup a locator for a received packet in its forwarding table and forward the packet accordingly. However, in some embodiments, one or more of spine switches A-N may be configured to host a proxy function that matches the endpoint address identifier to a locator mapping in a mapping database on behalf of leaf switches that do not have such mapping. For example, spine switch A can employ the proxy function to parse an encapsulated packet to identify a destination locator address of a corresponding tenant. Further, spine switch A can perform a local mapping lookup in a database to determine a correct locator address of the packet and forward the packet to the locator address without changing certain fields in the header of the packet. As shown, spine switches A-N can connect to leaf switches A-N and egress links A-B in fabric 205.

Leaf switches A-N can include access ports (or non-fabric ports) and fabric ports (not shown). Fabric ports typically provide uplinks to the spine switches, while access ports can provide connectivity for devices and/or networks, such as device(s) 130 (e.g., servers, hosts, VMs, etc.), or external networks, to fabric 205. Egress links A-B can reside at an edge of fabric 205, and can thus represent a network edge or egress point—e.g., PE-1A. In some cases, leaf switches A-N can be top-of-rack (“ToR”) switches configured according to a ToR architecture. In other cases, leaf switches A-N can be aggregation switches in any particular topology, such as end-of-row (EoR) or middle-of-row (MoR) topologies.

Leaf switches A-N can be configured to route and/or bridge tenant or customer packets and apply network policies. In some cases, a leaf switch can perform one or more additional functions, such as implementing a mapping cache, sending packets to a proxy function when there is a miss in the cache, encapsulate packets, enforce ingress or egress policies, communicate with a route reflector, perform load balancing operations, perform filtering operations, communicate with a load balancer or controller, etc. Moreover, one or more leaf switches A-N can contain virtual switching functionalities, including tunneling functionality (e.g., VPN tunneling, GRE tunneling, etc.) or encapsulation/decapsulation functionality (e.g., VXLAN encapsulation/decapsulation, etc.) to support network connectivity through fabric 205 and/or connect to an overlay network. In some embodiments, one or more leaf switches A-N can be configured as virtual tunnel endpoints (VTEPs) for routing traffic to and from an overlay network, such as a VXLAN for example.

As shown, leaf switches A-N can provide devices 130 (e.g., servers, network resources, processors, VMs, hosts, controllers, etc.) access to fabric 205. Thus, leaf switches A-N can connect devices 130 to other networks (e.g., core network 120, customer network 125, etc.).

Furthermore, in addition to egress links A-B, spine switches A-N and leaf switches A-N, fabric 205 can also include a controller 135 that can provide load balancing discussed herein. For example, controller 135 can receive service requests (e.g., packets and/or network flows) from the customer network 125 and perform specific load balancing operations to select a server from devices 130 to process the service request and an egress link from egress links A-B to carry the data and/or traffic associated with the service requests (e.g., response(s) from the selected server(s)) from network 110 to the core network 120 and/or customer network 125. For example, controller 135 can receive a service request and select a server from devices 130 and an egress link from egress links A-B. Controller 135 can then forward the service request to the selected server and include an indication of the selected egress link and/or an instruction to modify the selected server's forwarding table to map the selected egress link to the service request (e.g., associate data relating to the service request to the selected egress link for routing such data over the egress link).

Controller 135 can select an egress link from multiple egress links (e.g., egress links A-B) based on one or more factors, such as cost, bandwidth, data latency, packet loss, resource consumption and/or availability, quality of service (QoS) requirements, performance, reliability, traffic characteristics (e.g., class of service, etc.), traffic statistics, etc. For example, controller 135 can select an egress link by identifying the egress link that has the most bandwidth, most resource availability (e.g., memory, CPU, etc.), highest capacity, smallest queue, and/or or would result in a lowest cost, lowest latency, lowest packet loss, compliance with service criteria, etc. In selecting the egress link, controller 135 can monitor the egress links A-B (e.g., status, resource consumption, resource availability, queue, etc.) and/or traffic in the network 110. For example, controller 135 can track traffic metrics, activity, and/or statistics for the network 110 and/or egress links A-B to identify an optimal egress link (actual and/or estimated), such as the egress link with the most bandwidth, most resources, highest capacity, smallest queue, lowest cost, lowest latency, lowest packet loss, compliance with service criteria, etc. In addition, in selecting the egress link, controller 135 can analyze the service requirements, such as class of service, QoS, technical needs, performance agreements, etc. Thus, controller 135 can consider service criteria as well as traffic and/or device conditions or circumstances.

Once controller 135 selects an egress link for a service request, it can assign the selected egress link to the service request so any data associated with the service request will be routed out of network 110 through the selected egress link. For example, if controller 135 selects egress-B for a service request, the selected server from devices 130 can then route the data or traffic associated with that service request back to the customer network 125 through path 210 so the data or traffic for that service can egress from network 110 through egress-B.

As previously mentioned, controller 135 can also select a specific server or device from devices 130 for servicing a specific request. Here, controller 135 can perform load balancing operations to load balance service request. For example, controller 135 can identify multiple servers such as a server pool which can process or handle a particular service request. Controller 135 can then select one or more specific servers from the multiple servers to handle or process that particular service request and/or any network flows associated with that service request. Controller 135 can select a specific server based on a service criteria for the service request and/or current conditions associated with the multiple servers. In some cases, controller 135 can track current activity, statistics, and/or traffic associated with the multiple servers to select a specific server based on one or more factors, such as a current load, resource availability, service queue, server capabilities, event logs, a current circumstance, etc.

Once controller 135 selects a specific server to handle a request, it can forward the service request and/or any data associated with the service request to the specific server for processing and/or handling. Controller 135 can also provide an indication of which egress link should be used for responding to the service request. In some cases, controller 135 can modify a routing or forwarding table of the selected server to instruct the server to use the selected egress link for that service request. For example, controller 135 can map the service request with the egress link in a table such as a forwarding table used by the server to make routing or forwarding decisions for that service request or network flow. To illustrate, in some embodiments, controller 135 can map a 5-tuple representing the service request (e.g., destination address, source address, protocol, destination port, source port) with the egress link selected for that service request. In some cases, controller 135 can send a signal, command, and/or instruction to the selected server to prompt the server to store a mapping of the service request and selected egress link in a routing or forwarding table used by that server.

Controller 135 can monitor the devices 130, egress links A-B, and/or network traffic to dynamically make adjustments for handling or processing service requests. For example, controller 135 can track activity and statistics to select a different server and/or egress link for a network flow or service request. Controller 135 can thus dynamically steer service requests and/or network flows based on current conditions, circumstances, statistics, and/or criteria.

Controller 135 can be configured to communicate with one or more of the switches (i.e., spine switches A-N, leaf switches A-N, and/or egress links A-B) directly or indirectly within fabric 205 and/or within a network connected to fabric 205, such as an overlay network connected to leaf switches A-N. For example, in some cases, controller 135 can be a server or network device from devices 130 connected to one or more leaf switches.

Although fabric 205 is illustrated and described herein as an example leaf-spine architecture employing switches, one of ordinary skill in the art will readily recognize that the subject technology can employ any number of devices (e.g., routers, switches, servers, controllers, etc.), and may be implemented based on any network fabric, including any data center or cloud network fabric, for example. Indeed, other architectures, designs, infrastructures, and variations are contemplated herein. Further, any number of other devices (e.g., route reflectors, controllers, load balancers, proxies, etc.) can be included or excluded in other embodiments.

Moreover, as referenced herein, egress links can refer to specific devices, such as gateways; physical ports; logical ports; and/or port channels. Thus, in selecting an egress link for a service request, controller 135 can select a specific egress device, such as an edge leaf or router; a specific physical and/or logical port on a device; and/or a specific port channel. In some cases, controller 135 can perform load balancing of egress ports within one or more egress devices, such as border routers.

FIG. 3 illustrates a schematic diagram of an example system 300 for intelligent load balancing. Controller 135 can communicate with a pool of nodes 305, which can include devices (e.g., servers A-N) from the devices 130, to select specific devices to service requests received by the network 110. Controller 135 can also select egress links from the egress links A-N as the egress point for data and flows associated with the service request. As previously indicated, egress links A-N can reside within a border of the network 110 and serve as egress points for traffic leaving the network 110. Egress links A-N can include routers, gateways, physical and/or logical ports, port channels, and/or any physical/virtual egress point associated with network 110.

Controller 135 can select an egress link from the egress links A-N based on one or more factors, such as cost, bandwidth, data latency, packet loss, resource consumption and/or availability, quality of service (QoS) requirements, performance, reliability, traffic characteristics (e.g., class of service, etc.), traffic statistics, etc. For example, controller 135 can select an egress link by identifying the egress link that has the most bandwidth, most resource availability (e.g., memory, CPU, etc.), highest capacity, smallest queue, and/or or would result in a lowest cost, lowest latency, lowest packet loss, compliance with service criteria, etc. In selecting the egress link, controller 135 can monitor the egress links A-N (e.g., status, resource consumption, resource availability, queue, etc.) and/or traffic in the network 110. For example, controller 135 can track traffic metrics, activity, and/or statistics for the network 110 and/or egress links A-N to identify an optimal egress link (actual and/or estimated), such as the egress link with the most bandwidth, most resources, highest capacity, smallest queue, lowest cost, lowest latency, lowest packet loss, compliance with service criteria, etc. In addition, in selecting the egress link, controller 135 can analyze specific criteria or requirements associated with the service request, such as class of service, QoS, technical needs, performance agreements, etc. Thus, controller 135 can consider service criteria as well as traffic and/or device conditions or circumstances.

Once controller 135 selects an egress link for a service request, it can assign the selected egress link to the service request so any data associated with the service request will be routed out of network 110 through the selected egress link. Controller 135 can then inform a selected device from the pool of nodes 305 which egress link should be used for the service request.

As previously mentioned, controller 135 can select a specific device from the pool of nodes 305 (e.g., servers A-N) for servicing a specific service request. The controller 135 can perform load balancing operations to load balance the service request between the servers A-N. For example, controller 135 can select one or more specific servers from the servers A-N to handle or process the particular service request and/or any network flows associated with that service request. Controller 135 can select the specific server based on a service criteria for the service request and/or current conditions associated with the servers A-N. In some cases, controller 135 can track current activity, statistics, and/or traffic associated with the servers A-N to select a specific server based on one or more factors, such as a current load, resource availability, service queue, server capabilities, event logs, a current circumstance, etc.

Once controller 135 has selected a particular server and egress link, it can transmit the service request 310 to the selected server for processing. In some cases, the service request 310 can include the original service request from the subscriber or customer. In other cases, the service request 310 can include a new request generated by controller 135 based on the original request. In yet other cases, the service request 310 can include a portion of the original request and/or a portion of additional data created by the controller 135.

In some embodiments, the service request 310 can include information about the selected egress link. For example, the service request 310 can identify the selected egress link to be used by the selected server for servicing the service request 310. In some embodiments, the service request 310 can include a signal, command, and/or instruction for amending a table, such as a forwarding or routing table, at the selected server to identify the selected egress link as the egress link to be used for the service request 310. For example, the service request 310 can include an instruction or command for modifying a forwarding table at the selected server to map the selected egress link with the service request 310. In some cases, the service request 310 can include a request to add an entry into the selected server's forwarding table to map the service request with a label stack for steering any network packets associated with the service request 310 to the selected egress link. In some cases, the label or label stack can include an MPLS label. However, in other cases, the label or label stack can be associated with one or more other protocols.

In some cases, controller 135 can monitor the selected egress link and/or server to dynamically adapt which server and/or egress link should be associated with one or more service requests. For example, assume that controller 135 selects egress link-A and server-B for service request 310. Controller 135 can then send the service request 310 to server-B, steering the service request 310 and/or associated responses through egress link-A. Controller 135 can continue to monitor one or more of the egress links A-N to dynamically select a different egress link if there is a change in the circumstances, conditions, criteria, performance, etc. For example, if controller 135 determines that egress link-B has more bandwidth, it can dynamically modify the egress point for the service request 310 from egress link-A to egress link-B. As another example, if controller 135 initially selects a high cost link, such as egress link-A, for service request 310, it can later switch to an egress link with a lower cost, such as egress link-B. In this way, controller 135 can track performance, conditions, and/or criteria and update previous egress link selections or mappings.

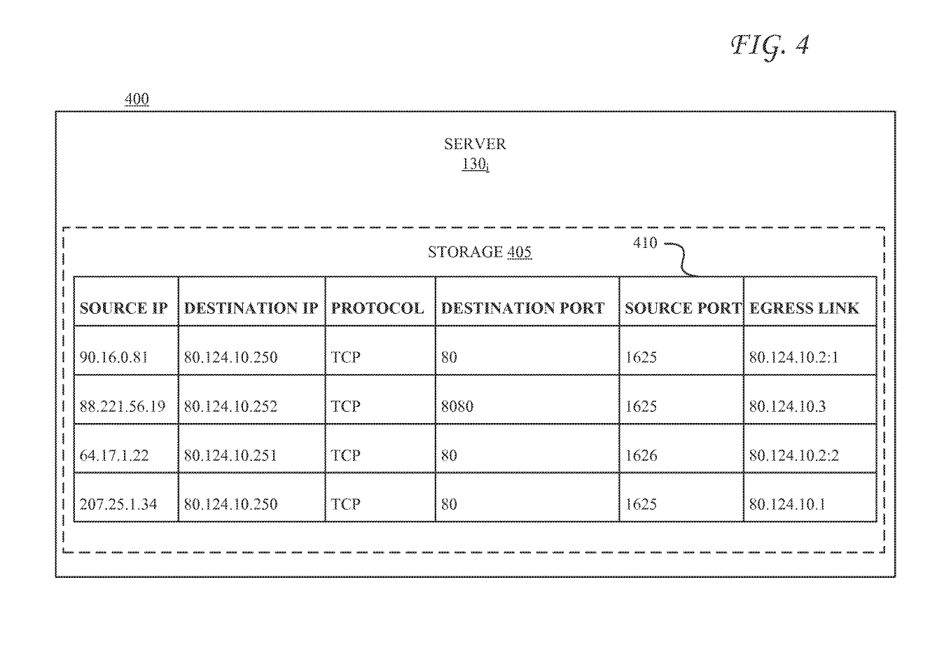

FIG. 4 illustrates an example diagram 400 of a forwarding table 410 for intelligent load balancing. The forwarding table 410 can be stored in a storage 405 associated with a server 130, from devices 130. The storage 404 can be a memory, a hard drive, a disk, a table, a database, a file, a folder, and/or any other physical and/or logical storage space. Moreover, server 130i can be directly or indirectly coupled with the storage 405.

The forwarding table 410 can include data identifying a network flow or service request and data identifying an egress link for that network flow or service request. For example, a row in the forwarding table 410 can include a source address, destination address, protocol, destination port, and source port, which identify a particular network flow or service request. The row can also include information identifying an egress link for that particular network flow or service request, such as an address, a label, a port, and/or any other identifying information.

As one of ordinary skill in the art will readily recognize, the forwarding table 410 can include more or less information and type of information in other embodiments. Indeed, the forwarding table 410 and information in the table 410 is provided as a non-limiting example for explanation purposes and simplicity.

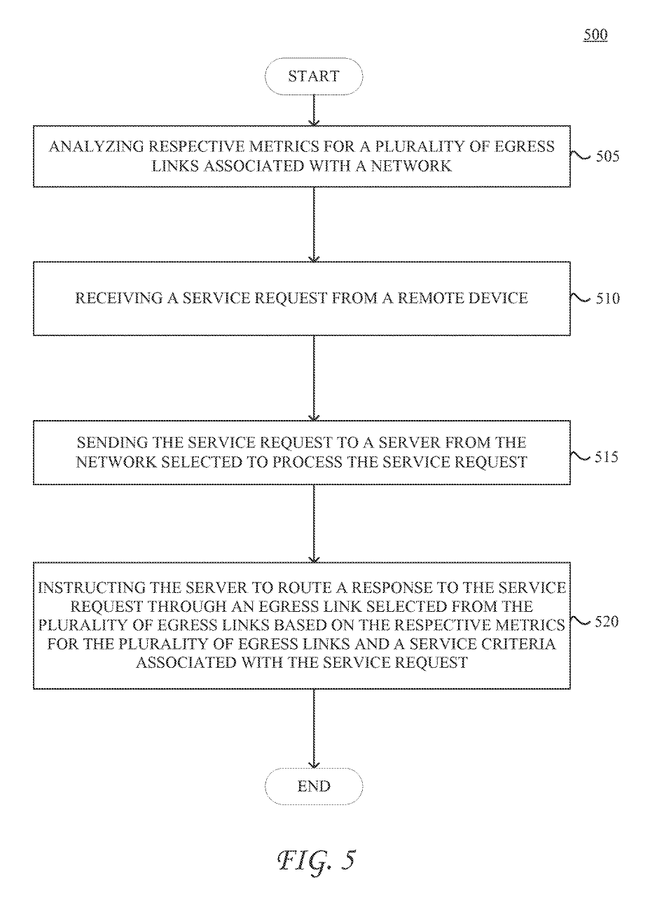

Having disclosed some basic system components and concepts, the disclosure now turns to the example method embodiment 500 shown in FIG. 5. For the sake of clarity, the method is described in terms of controller 135, as shown in FIGS. 1 and 2, configured to practice the method. The steps outlined herein are exemplary and can be implemented in any combination thereof, including combinations that exclude, add, or modify certain steps.

At step 505, controller 135 analyzes respective metrics for multiple egress links associated with a network. The egress links can include egress devices, such as edge routers, and/or ports on one or more egress devices. Moreover, the respective metrics can include traffic data or statistics, egress link statistics, network statistics, device statistics, etc. For example, the respective metrics can include performance statistics for the egress links, resource consumption for the egress links, cost information for the egress links, bandwidth associated with the egress links, availability of the egress links, current load and/or packets for the egress links, queues for the egress links, etc.

At step 510, controller 135 can receive a service request from a remote device and/or location. For example, controller 135 can receive a content and/or service request, such as an OTT service request, from a subscriber or customer. The service request can originate from a device located outside of the network where the controller 135 resides and/or where the device(s) that are to service the request reside.

At step 515, controller 135 can send the service request to a server from the network selected to process the service request. The server can be one or more servers selected by the controller 135 from a pool of nodes or servers. Controller 135 can select the server based on a load balancing operation. For example, controller 135 can select the server based on a current condition associated with the servers and/or a criteria associated with the service request.

At step 520, controller 135 can instruct the server to route a response to the service request through an egress link selected from the egress links based on the respective metrics for the egress links and/or a service criteria associated with the service request. In some embodiments, controller 135 can instruct the server by sending an indication of the selected egress link with the service request sent by controller 135 to the server. For example, controller 135 can include the identification of the selected egress link within the service request it sends to the server (e.g., embedded within the service request), or may otherwise send the identification separately from the service request before the server processes the service request (e.g., prior to sending the service request, along with the service request, or after sending the service request but before the server processing the service request).

In some embodiments, to instruct the server to route the response through the selected egress link, controller 135 can send an instruction and/or command to the server to instruct the server. The instruction and/or command can be part of the service request or separate from the service request. Moreover, in some cases, the instruction and/or command can instruct the server to modify its forwarding table and/or add an entry to its forwarding table so as to steer or route any traffic associated with the service request through the selected egress link. For example, the instruction and/or command can initiate a procedure or operation for mapping the service request and/or any associated traffic with the selected egress link. In some embodiments, controller 135 can modify the server's forwarding or routing table to include an association of the service request and the selected egress link. Controller 135 can also monitor the server's forwarding or routing table to identify forwarding settings, modify or adjust forwarding settings, and/or perform certain analytics, such as cost or path metrics.

In some embodiments, controller 135 can monitor the service request, including any traffic or responses associated with the service request, to make any adjustments to the egress link that should be used to route traffic associated with the service request. Controller 135 can dynamically make such adjustments as needed or at specific times such as events, triggers, schedules, intervals, operations, transactions, etc. For example, controller 135 can monitor the processing of the service request and dynamically adjust the egress link selection to optimize which egress link is used by the server to route the traffic associated with the service request.

In some embodiments, controller 135 can also monitor the selected egress link and/or any other egress links, as well as any associated statistics (e.g., performance, bandwidth, cost, latency, packet loss, jitter, availability, resource consumption and availability, etc.) to adjust what egress link is used to route the traffic associated with the service request.

To select the egress link from the egress links, controller 135 can monitor the network and/or egress links to make a selection. For example, controller 135 can monitor traffic statistics in the network, traffic statistics for each egress link, and/or other statistics or activity for each of the egress links, such as bandwidth, cost, jitter, latency, packet loss, performance, resources, etc. In some cases, controller 135 can also monitor criteria and/or requirements associated with the service request, such as QoS, CoS, performance requirements, request details, etc.

In some embodiments, controller 135 can select egress links at the device level. For example, controller 135 can select a specific device from multiple devices to use as an egress device. In other embodiments, controller 135 can select egress links at the port level. For example, controller 135 can select a specific port or port channel from multiple ports and/or port channels as an egress point to carry traffic for a service request from the network to the remote destination. The multiple ports or port channels can be physical and/or logical ports. Moreover, the multiple ports or port channels can reside on one or more devices. For example, in some cases, the multiple ports or port channels can be ports or port channels on the same device. Here, controller 135 can select a port or port channel from multiple ports or port channels on the same device to use as the egress point. In other cases, the multiple ports or port channels can be ports or port channels on different devices. Here, controller 135 can select a port or port channel from multiple ports or port channels on different devices to use as the egress point.

### Example Devices

FIG. 6 illustrates an example network device 610 suitable for routing, switching, forwarding, traffic management, and load balancing. Network device 610 can be, for example, a router, a switch, a controller, a server, a gateway, and/or any other L2 and/or L3 device.

Network device 610 can include a master central processing unit (CPU) 662, interfaces 668, and a bus 615 (e.g., a PCI bus). When acting under the control of appropriate software or firmware, the CPU 662 is responsible for executing packet management, error detection, load balancing operations, and/or routing functions. The CPU 662 can accomplish all these functions under the control of software including an operating system and any appropriate applications software. CPU 662 may include one or more processors 663, such as a processor from the Motorola family of microprocessors or the MIPS family of microprocessors. In an alternative embodiment, processor 663 is specially designed hardware for controlling the operations of network device 610. In a specific embodiment, a memory 661 (such as non-volatile RAM and/or ROM) also forms part of CPU 662. However, there are many different ways in which memory could be coupled to the system.

The interfaces 668 are typically provided as interface cards (sometimes referred to as “line cards”). Generally, they control the sending and receiving of data packets over the network and sometimes support other peripherals used with the network device 610. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 662 to efficiently perform routing computations, network diagnostics, security functions, etc.

Although the system shown in FIG. 6 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 661) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

FIG. 7A and FIG. 7B illustrate example system embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates an example computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output device 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that example systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

We claim:

1. A method comprising:
analyzing respective metrics for a plurality of egress links associated with a network;
receiving, by a network device associated with the network, a service request from a remote device;
sending, by the network device, the service request to a server from the network selected to process the service request; and
instructing the server to route a response to the service request through an egress link selected from the plurality of egress links based on the respective metrics for the plurality of egress links and a service criteria associated with the service request.

2. The method of claim 1, wherein the service request comprises a network flow, and wherein instructing the server to route the response through the egress link comprises:
selecting the egress link from the plurality of egress links based on the respective metrics for the plurality of egress links and the service criteria associated with the service request; and
sending, to the server, an instruction to modify a forwarding table associated with the server to associate the egress link with the network flow.

3. The method of claim 2, wherein sending the instruction to modify the forwarding table associated with the server to associate the egress link with the network flow comprises:
mapping the network flow to a label stack that identifies the egress link.

4. The method of claim 3, wherein mapping the network flow to the label comprises mapping a 5-tuple associated with the network flow to the label stack, the 5-tuple comprising a source address, a destination address, a protocol, a source port, and a destination port.

5. The method of claim 3, wherein the label stack comprises a multiprotocol label switching (MPLS) label stack.

6. The method of claim 1, wherein the service criteria comprises at least one of a cost, a bandwidth, a latency, and a packet loss, and wherein the respective metrics comprise, for each respective egress link, at least one of an amount of traffic processed by the respective egress link, an amount of resources used by the respective egress link, an amount of resources available by the respective egress link, a performance associated with the respective egress link, and a cost associated with the respective egress link.

7. The method of claim 1, wherein instructing the server to route the response through the egress link comprises:
selecting the egress link from the plurality of egress links based on a comparison of the respective metrics associated with the plurality of egress links, the respective metrics comprising, for each of the plurality of egress links, at least one of a respective cost, a respective bandwidth, a respective latency, and a respective packet loss.

8. The method of claim 1, further comprising:
selecting a different egress link from the plurality of egress links based on at least one of respective metrics and the service criteria; and
instructing the server to route a future response to the service request through the different egress link.

9. The method of claim 8, further comprising:
monitoring the plurality of egress links to yield respective updated metrics; and
dynamically selecting the different egress link based on the updated metrics.

10. The method of claim 9, further comprising:
sending an instruction to the server to modify a forwarding table associated with the server to associate the service request with the different egress link.

11. The method of claim 1, wherein the server from the network is selected to process the service request from a plurality of servers based on respective server metrics associated with the plurality of servers, the respective server metrics comprising at least one of a respective bandwidth, a respective load, a respective amount of resources available, a respective amount of associated service requests, and a respective status.

12. A system comprising:
a processor; and
a computer-readable storage medium having stored therein instructions which, when executed by the processor, cause the processor to perform operations comprising:
analyzing respective metrics for a plurality of egress links associated with a network;
receiving a service request from a remote device;
sending the service request to a server from the network, the server being selected to process the service request from a plurality of servers; and
instructing the server to route a response to the service request through an egress link selected from the plurality of egress links based on the respective metrics for the plurality of egress links and a service criteria associated with the service request.

13. The system of claim 12, wherein the service request comprises a network flow, and wherein instructing the server to route the response through the egress link comprises:
selecting the egress link from the plurality of egress links based on the respective metrics for the plurality of egress links and the service criteria associated with the service request; and
sending, to the server, a request to modify a forwarding table associated with the server to associate the egress link with the network flow.

14. The system of claim 13, wherein sending the instruction to modify the forwarding table associated with the server to associate the egress link with the network flow comprises:
mapping the network flow to a label that identifies the egress link.

15. The system of claim 14, wherein mapping the network flow to the label comprises mapping a 5-tuple associated with the network flow to the label stack, the 5-tuple comprising a source address, a destination address, a protocol, a source port, and a destination port.

16. The system of claim 12, wherein the service criteria comprises at least one of a cost, a bandwidth, a latency, and a packet loss, and wherein the respective metrics comprise, for each respective egress link, at least one of an amount of traffic processed by the respective egress link, an amount of resources used by the respective egress link, an amount of resources available by the respective egress link, a performance associated with the respective egress link, and a cost associated with the respective egress link.

17. A non-transitory computer-readable storage medium having stored therein instructions which, when executed by a processor, cause the processor to perform operations comprising:
analyzing activity data for a plurality of egress links associated with a network;
receiving, by a network device associated with the network, a service request originating from a remote device;
selecting, by the network device, a server from a plurality of servers in the network for receiving the service request;
based on the activity data, selecting, by the network device, a link from the plurality of egress links in the network as an egress link in the network assigned to communicate data associated with the service request from the network to a remote destination location; and
sending, by the network device, a signal to the selected server, the signal comprising the service request and an indication of the link to be used as the egress link for data associated with the service request.

18. The non-transitory computer-readable storage medium of claim 17, wherein the activity data comprises at least one of a respective amount of traffic processed by the plurality of egress links, a respective amount of resources used by the plurality of egress links, a respective amount of resources available to the plurality of egress links, a respective performance associated with the plurality of egress links, and a respective cost associated with the plurality of egress links.

19. The non-transitory computer-readable storage medium of claim 17, wherein the link is selected further based on a service criteria comprising at least one of a cost, a bandwidth, a latency, and a packet loss.

20. The non-transitory computer-readable storage medium of claim 17, wherein the service request comprises a network flow, and wherein the signal comprises an instruction to modify a forwarding table associated with the server to associate the selected link with the network flow.
